(19) United States
(12) Patent Application Publication
(10) Pub. No.: US 2022/0194360 A1
(43) Pub. Date: Jun. 23, 2022

(54) SYSTEM AND METHOD FOR OPERATING A VEHICLE

(71) Applicant: Ford Global Technologies, LLC, Dearborn, MI (US)

(72) Inventors: Keith Weston, Canton, MI (US); Brendan Diamond, Grosse Pointe, MI (US); Ryan Orourke, Dearborn, MI (US); Seth Loveall, Dearborn, MI (US); Jonathan Hair, Royal Oak, MI (US)

(21) Appl. No.: 17/129,630

(22) Filed: Dec. 21, 2020

(51) Int. Cl. B60W 30/02; B60W 30/18; B60W 10/08; B60W 30/14; B60W 10/22; B60W 30/182

(52) U.S. Cl. CPC B60W 30/02; B60W 30/18172; B60W 10/08; B60W 2520/10; B60W 10/22; B60W 30/182; B60W 2520/28; B60W 30/143

(57) ABSTRACT

Methods and system are described for controlling operation of a driveline during off-road maneuvers. In one example, electric machines included in the driveline may be switched from a torque or power control mode to a speed control mode to improve vehicle stability. The methods and systems may be applied to a variety of driveline configurations.

### FIELD

The present description relates generally to methods and systems for controlling operation of a vehicle that experiences lifting of one or more tires/wheels from earth. The method and system control speed of one or more vehicle tires/wheels.

### BACKGROUND/SUMMARY

A vehicle may operate off-road from time to time. Operation of the vehicle may not be constrained to the extent that it may be constrained while operating the vehicle on a public road. For example, the vehicle may climb rocks, negotiate curves around trees, jump over bumps on the earth, move across ditches, and move over a wide variety of surfaces. During such travels, the vehicle may lose traction causing the vehicle's tires and wheels to rotate at a higher speed than they would otherwise rotate at the same vehicle ground speed. The loss of traction may reduce vehicle stability in a way that is not desired. Therefore, it may be desirable to provide a way of improving vehicle stability while a vehicle is driving off-road.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of an example vehicle driveline is shown;

FIG. 2 shows a vehicle operating in an example off-road environment;

FIGS. 3A-3C show a perspective view of a vehicle and portions of the vehicle's suspension;

FIGS. 4 and 5 show an example operating sequence according to the method of FIG. 6;

FIG. 6 shows a flowchart of a method to operate a vehicle during off-road operating conditions; and

FIGS. 7-13 show example vehicle configurations in which the present method may be applied.

### DETAILED DESCRIPTION

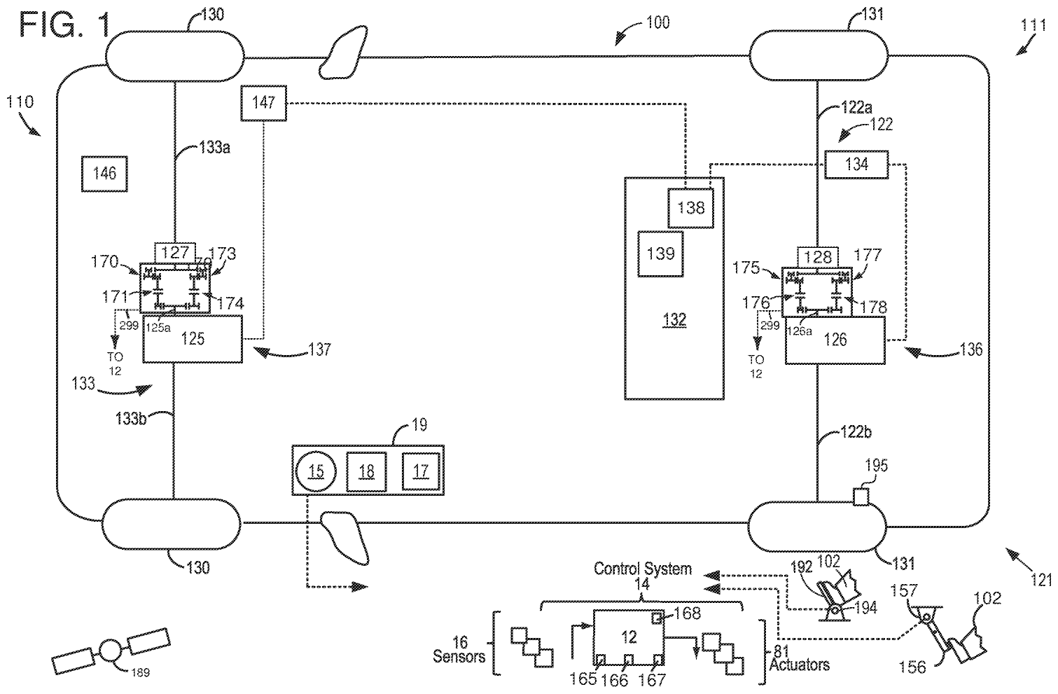

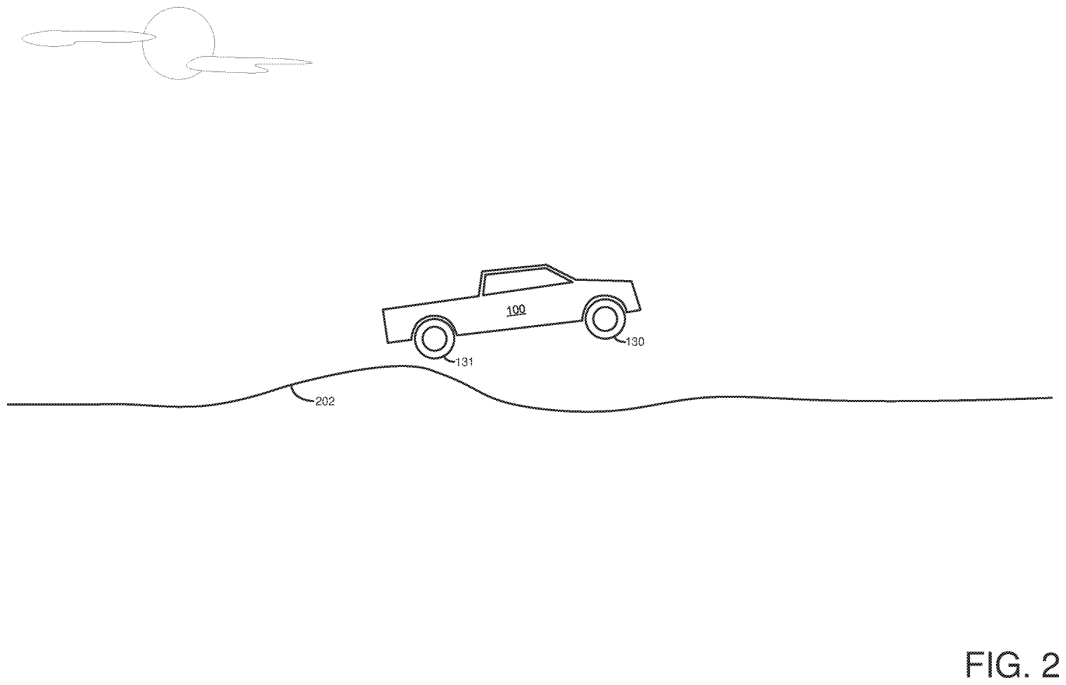

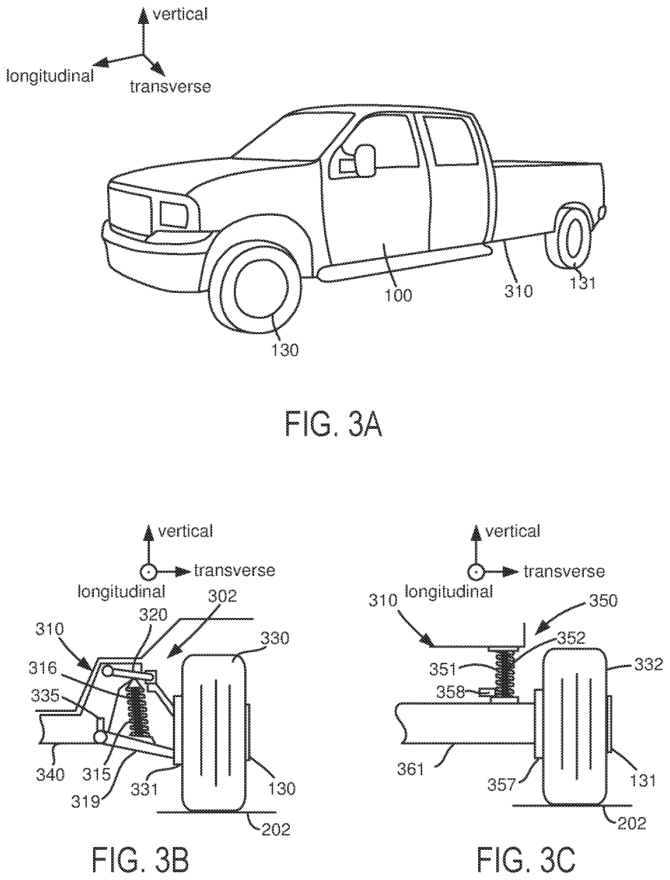

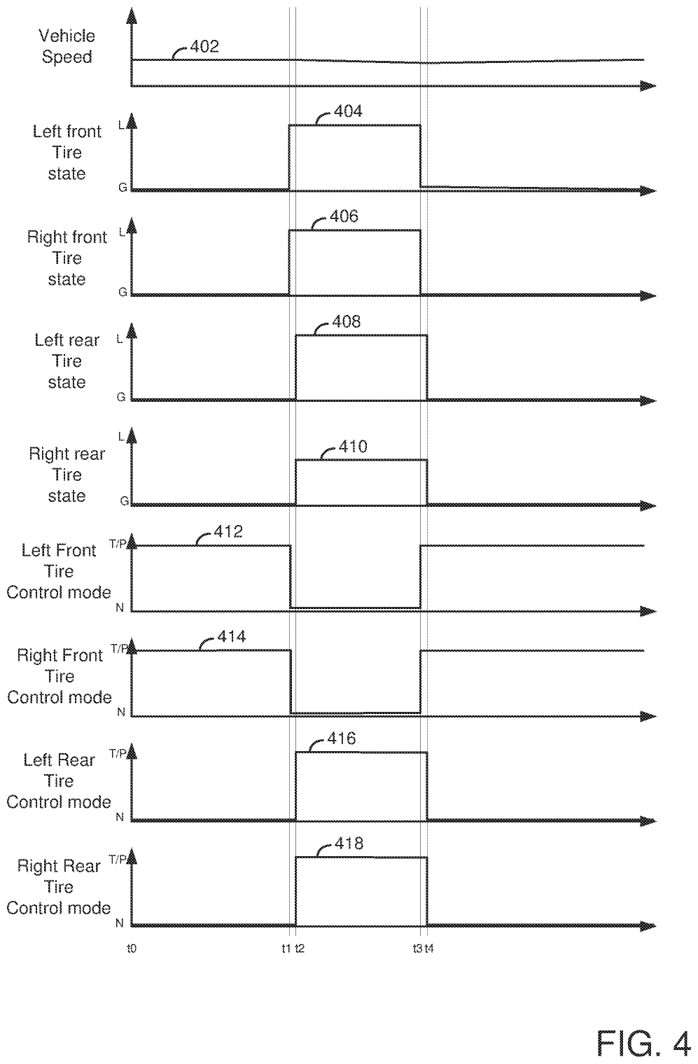

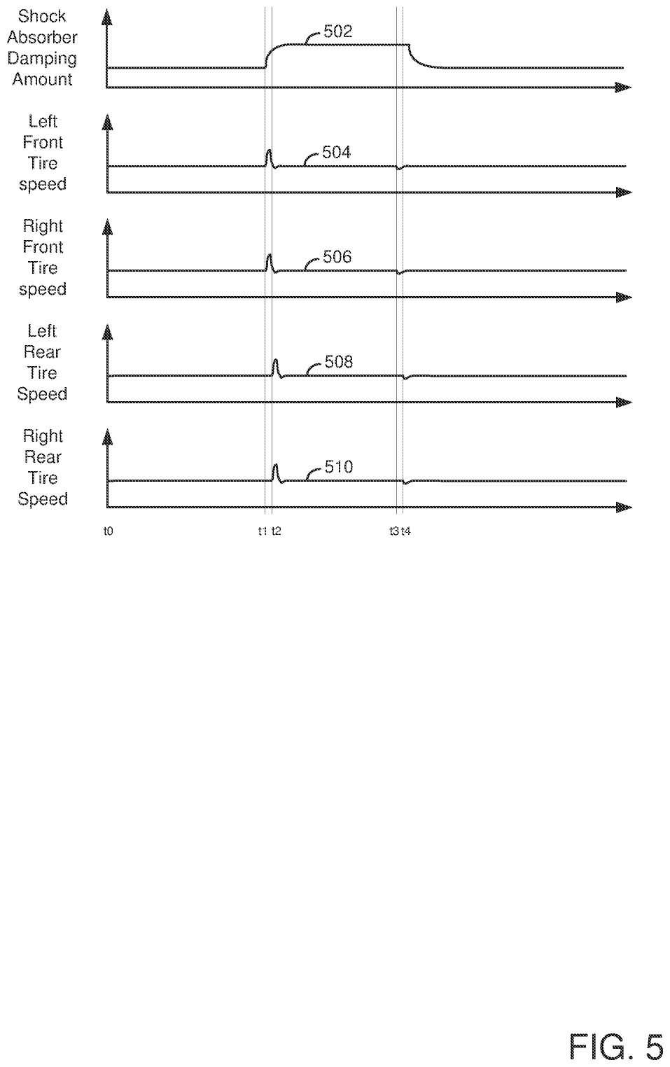

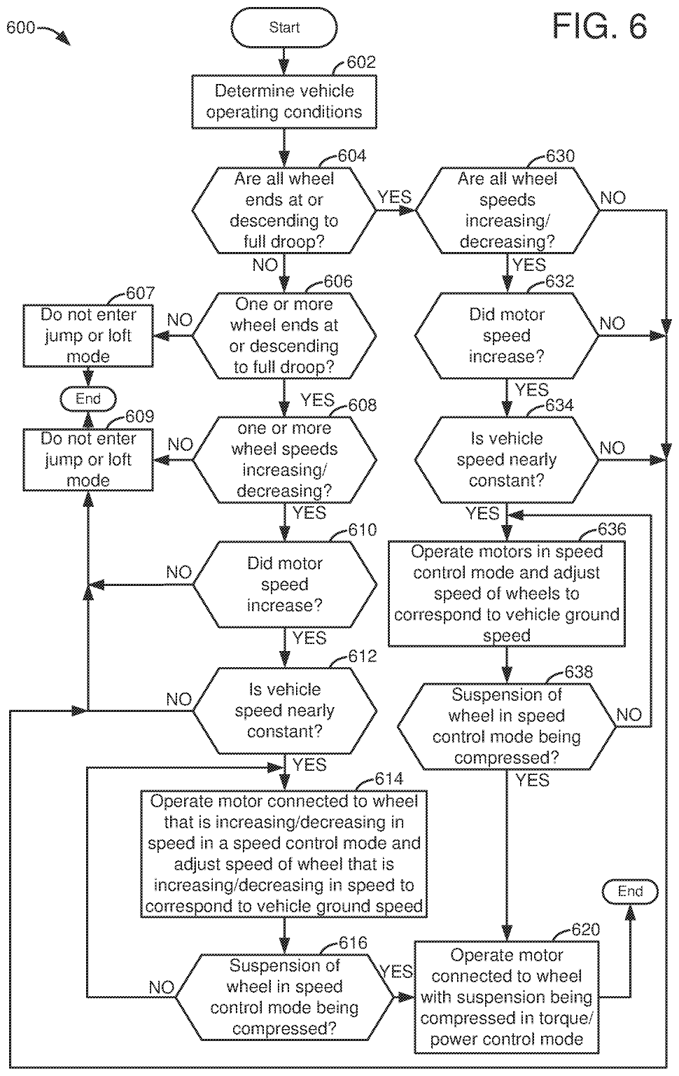

The following description relates to systems and methods for improving vehicle operation during off-road conditions. Specifically, vehicle operation may be improved when one or more of the vehicle's tires lift above the earth. An example vehicle and driveline or powertrain is shown in FIG. 1. FIG. 2 shows an example off-road environment where the method described herein may be put to use. An example vehicle and portions of its suspension system are shown in FIGS. 3A-3C. An example vehicle operating sequence according to the method of FIG. 6 is shown in FIGS. 4 and 5. A method for operating a vehicle is shown in FIG. 6. The method described herein may be applied to the example vehicle configurations shown in FIGS. 1 and 7-13.

A vehicle that operates off-road may have one or more of the vehicle's tires lift from the earth. The speed of the tire that has left the earth may increase since the earth is no longer opposing the tire's motion. In addition, if the vehicle leaves the earth via a ramp or bump in the earth's surface, speeds of all of the vehicle's tires may increase if all the vehicle's tires leave the earth and the vehicle becomes airborne. Speed of the tires that increase may decrease vehicle stability if the tires are rotating above a speed that corresponds to the vehicle's ground speed (e.g., a speed equivalent to the present speed at which the vehicle is moving relative to earth ground when all four tires of the vehicle are in contact with the earth and freely rotating such that the tires may not be slipping). It should be appreciated that vehicle instability may result when tires that spin above or below a speed at which the tires would rotate if the vehicle were traveling with all of its tires on the ground and without tire slip at the present vehicle speed come in contact with the earth. Therefore, it may be desirable to provide a way that may reduce vehicle instability when a spinning tire encounters earth after the tire has been lifted from the earth. However, it may be possible to improve vehicle performance by adjusting tire/wheel speed to a desired speed that is above or below a speed at which the tires would rotate if the vehicle were traveling with all of its tires on the ground and without tire slip during some conditions. As such, the tire/wheel speed may be rotated at a speed that is a predetermined speed above or below a speed at which the tires would rotate if the vehicle were traveling with all of its tires on the ground and without tire slip at the present vehicle speed. The predetermined speed may be based on present vehicle speed, driving surface composition, and intended vehicle action (e.g., braking or speed increasing) when the vehicle lands. The intended vehicle action may be determined from positions of the brake pedal and the propulsive effort pedal.

The inventors herein have recognized the above-mentioned issues and have developed a method for operating a vehicle, comprising: operating an electric machine in a torque control mode or a power control mode; and switching the electric machine from the torque control mode or the power control mode into a speed control mode in response to an indication that one or more vehicle tires has lost contact with earth.

By switching operation of an electric machine from a torque or power control mode to a speed control mode, it may be possible to adjust tire and wheel speed to a speed that matches with vehicle speed relative to earth so that when a spinning tire encounters earth, less vehicle yaw may be generated. In one example, where all vehicle tires are airborne, all vehicle tires may be adjusted to a same speed so that less torque may be generated between the rotating tires and the earth, thereby reducing the possibility of generating larger amounts of vehicle yaw. In other situations, wheel speed differentials between wheels may be helpful in improving landing characteristics (slightly higher front axle wheel speed) or differential speeds (slightly higher left or right wheels speed) to mitigate vehicle yaw.

The present description may provide several advantages. In particular, the approach may improve vehicle stability if a tire loses contact with earth. In addition, the approach may stop vehicle tires from increasing or decreasing to undesirable speeds. Further, the approach may improve driveline durability by reducing torque disturbances through the driveline when a once elevated tire encounters earth.

FIG. 1 illustrates an example vehicle propulsion system 100 for vehicle 121. A front portion of vehicle 121 is indicated at 110 and a rear portion of vehicle 121 is indicated at 111. Vehicle propulsion system 100 includes at two propulsion sources including front electric machine 125 and rear electric machine 126. Electric machines 125 and 126 may consume or generate electrical power depending on their operating mode. Throughout the description of FIG. 1, mechanical connections between various components are illustrated as solid lines, whereas electrical connections between various components are illustrated as dashed lines.

Vehicle propulsion system 100 has a front axle 133 and a rear axle 122. In some examples, rear axle may comprise two half shafts, for example first half shaft 122a, and second half shaft 122b. Likewise, front axle 133 may comprise a first half shaft 133a and a second half shaft 133b. Vehicle propulsion system 100 further has front wheels 130 and rear wheels 131. In this example, front wheels 130 may be selectively driven via electric machine 125. Rear wheels 131 may be driven via electric machine 126.

The rear axle 122 is coupled to electric machine 126. Rear drive unit 136 may transfer power from electric machine 126 to axle 122 resulting in rotation of drive wheels 131. Rear drive unit 136 may include a low gear set 175 and a high gear 177 that are coupled to electric machine 126 via output shaft 126a of rear electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over CAN 299. Alternatively, high gear clutch 178 and low gear clutch 176 may be opened and closed via digital outputs or pulse widths provided via control system 14. Rear drive unit 136 may include differential 128 so that torque may be provided to axle 122a and to axle 122b. In some examples, an electrically controlled differential clutch (not shown) may be included in rear drive unit 136.

The front axle 133 is coupled to electric machine 125. Front drive unit 137 may transfer power from electric machine 125 to axle 133 resulting in rotation of drive wheels 130. Front drive unit 137 may include a low gear set 170 and a high gear 173 that are coupled to electric machine 125 via output shaft 125a of front electric machine 125. Low gear 170 may be engaged via fully closing low gear clutch 171. High gear 173 may be engaged via fully closing high gear clutch 174. High gear clutch 174 and low gear clutch 171 may be opened and closed via commands received by front drive unit 137 over CAN 299. Alternatively, high gear clutch 174 and low gear clutch 171 may be opened and closed via digital outputs or pulse widths provided via control system 14. Front drive unit 137 may include differential 127 so that torque may be provided to axle 133a and to axle 133b. In some examples, an electrically controlled differential clutch (not shown) may be included in rear drive unit 136.

Electric machines 125 and 126 may receive electrical power from onboard electrical energy storage device 132. Furthermore, electric machines 125 and 126 may provide a generator function to convert the vehicle's kinetic energy into electrical energy, where the electrical energy may be stored at electric energy storage device 132 for later use by the electric machine 125 and/or electric machine 126. A first inverter system controller (ISC1) 134 may convert alternating current generated by rear electric machine 126 to direct current for storage at the electric energy storage device 132 and vice versa. A second inverter system controller (ISC2) 147 may convert alternating current generated by front electric machine 125 to direct current for storage at the electric energy storage device 132 and vice versa. Electric energy storage device 132 may be a battery, capacitor, inductor, or other electric energy storage device.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 14 may communicate with one or more of electric machine 125, electric machine 126, energy storage device 132, etc. Control system 14 may receive sensory feedback information from one or more of electric machine 125, electric machine 126, energy storage device 132, etc. Further, control system 14 may send control signals to one or more of electric machine 125, electric machine 126, energy storage device 132, etc., responsive to this sensory feedback. Control system 14 may receive an indication of an operator requested output of the vehicle propulsion system from a human operator 102, or an autonomous controller. For example, control system 14 may receive sensory feedback from pedal position sensor 194 which communicates with pedal 192. Pedal 192 may refer schematically to a propulsive effort pedal. Similarly, control system 14 may receive an indication of an operator requested vehicle braking via a human operator 102, or an autonomous controller. For example, control system 14 may receive sensory feedback from pedal position sensor 157 which communicates with brake pedal 156.

Energy storage device 132 may periodically receive electrical energy from a power source such as a stationary power grid (not shown) residing external to the vehicle (e.g., not part of the vehicle). As a non-limiting example, vehicle propulsion system 100 may be configured as a plug-in electric vehicle (EV), whereby electrical energy may be supplied to energy storage device 132 via the power grid (not shown).

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 12). Power distribution module 138 controls flow of power into and out of electric energy storage device 132.

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Vehicle propulsion system 100 may further include a motor electronics coolant pump (MECP) 146. MECP 146 may be used to circulate coolant to diffuse heat generated by at least electric machine 120 of vehicle propulsion system 100, and the electronics system. MECP may receive electrical power from onboard energy storage device 132, as an example.

Controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) (not shown), wheel speed sensor(s) 195, etc. In some examples, sensors associated with electric machine 125, electric machine 126, wheel speed sensor 195, etc., may communicate information to controller 12, regarding various states of electric machine operation. Controller 12 includes non-transitory (e.g., read only memory) 165, random access memory 166, digital inputs/outputs 168, and a microcontroller 167.

Vehicle propulsion system 100 may also include an on-board navigation system 17 (for example, a Global Positioning System (GPS)) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites 189, and from the signal identify the geographical location of the vehicle, vehicle speed, and direction of vehicle travel. In some examples, the geographical location coordinates may be communicated to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via controller (e.g. 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or terminate operation of the vehicle driveline (e.g., electric machine 125 and electric machine 126) based on an operator input. Various examples of the operator ignition interface 15 may include interfaces that require a physical apparatus, such as an active key, that may be inserted into the operator interface 15 to start the electric machines 125 and 126 and to turn on the vehicle, or may be removed to shut down the electric machines 125 and 126 to turn off the vehicle. Other examples may include a passive key that is communicatively coupled to the operator interface 15. The passive key may be configured as an electronic key fob or a smart key that does not have to be inserted or removed from the interface 15 to operate the vehicle electric machines 125 and 126. Rather, the passive key may need to be located inside or proximate to the vehicle (e.g., within a threshold distance of the vehicle). Still other examples may additionally or optionally use a start/stop button that is manually pressed by the operator to start or shut down the electric machines 125 and 126 to turn the vehicle on or off. In other examples, a remote electric machine start may be initiated remote computing device (not shown), for example a cellular telephone, or smartphone-based system where a user's cellular telephone sends data to a server and the server communicates with the vehicle controller 12 to start the engine.

The system of FIG. 1 provides for a vehicle system, comprising: a first electric machine coupled to a wheel and a tire; a controller including executable instructions stored in non-transitory memory that cause the controller to operate the first electric machine in a torque or power control mode when the tire is in direct contact with earth, and operate the first electric machine in a speed control mode when the tire is not in direct contact with earth. The system further comprises additional instructions to rotate the tire while the tire is not in contact with earth at a speed that is based on a speed of a second tire. The system further comprises additional instructions to rotate the tire while the tire is not in contact with earth at a speed that is based on a speed of a second tire, the second tire a last tire of a vehicle in contact with earth. The system includes where the tire is rotated at the speed when all tires are not in contact with earth. The system further comprises a second electric machine and additional instructions to operate the second electric machine in the torque or power control mode while the first electric machine is operated in the speed control mode. The system further comprises a second electric machine and additional instructions to operate the second electric machine in a second speed control mode while the first electric machine is operated in the speed control mode. The system further comprises additional instructions to determine that the tire is not in direct communication with earth based on a speed change of the first electric machine. The system further comprises additional instructions to determine that the tire is not in direct communication with earth based on output of a suspension sensor.

Referring now to FIG. 2, an example vehicle and its operating environment are shown. Vehicle 100 is show with front wheels 130 and rear wheels 131 lifted off of earth 202. Vehicle 100 is shown being operate off-road where it may be possible to perform such maneuvers. Front wheels 130 and rear wheels 131 may be rotated at a speed that is a function or based on a speed of vehicle 100 relative to earth 202. By rotating the front wheels 130 and the rear wheels 131 at this speed when front wheels 130 and rear wheels 131 are not in contact with earth 202, it may be possible to reduce vehicle yaw and improve vehicle stability when front wheels 130 and rear wheels 131 land.

Turning now to FIG. 3A, a perspective view of example vehicle 100 is shown. Vertical, longitudinal, and transverse directions are indicted via the illustrated coordinates. Sprung chassis components are components that are supported via suspension springs. Thus, body 310 is a sprung mass while wheels 130 and 131 are an unsprung mass.

FIG. 3B shows half of an example front chassis suspension 302 for vehicle 100 or a similar vehicle. Tire 330 is mounted to a wheel 130 and the wheel 130 is mounted to hub 331. Hub 331 is mechanically coupled to lower control arm 319 and upper control arm 320. Upper control arm 320 and lower control arm 319 may pivot about chassis support 340, which may be part of the vehicle's body 310. Spring 315 is coupled to chassis support 340 and lower control arm 319 such that spring 315 supports chassis support 340. Hub 331, upper control arm 320, and lower control arm 319 are unsprung since they are not supported by spring 315 and they move according to a surface of the road the vehicle is traveling on. A damper or shock absorber 316 may accompany spring 315 to provide a second order system. Vehicle suspension height sensor 335 provides an indication of a position of front chassis suspension 302. Vehicle suspension height sensor 335 may indicate when front chassis suspension 302 is in a full droop position such that tire 330 is not in contact with earth 202. Vehicle suspension height sensor 335 may also indicate when chassis suspension 302 is compressed and in contact with earth 202.

FIG. 3C shows half of an example rear chassis suspension 350 for vehicle 100 or a similar vehicle. Tire 332 is mounted to a wheel 131 and the wheel 13 is mounted to hub 357. Hub 357 is mechanically coupled to axle 361. Spring 351 is coupled to chassis 310 and axle 361. Hub 357 and axle 361 are unsprung since they are not supported by spring 351 and they move according to a surface of the road the vehicle is traveling on. A damper or shock absorber 352 may accompany spring 351 to provide a second order system. Vehicle suspension height sensor 358 provides an indication of a position of rear chassis suspension 350. Vehicle suspension height sensor 335 may indicate when rear chassis suspension 350 is in a full droop position such that tire 332 is not in contact with earth 202. Vehicle suspension height sensor 358 may also indicate when rear chassis suspension 350 is compressed and in contact with earth 202.

The spring rates of springs 315 and 351 may be adjustable via control system 14. Further, a damping rate of shock absorbers 316 and 352 may be adjustable via control system 14. By adjusting damping and spring rates, vehicle stability may be adjusted for driving conditions and driving surface.

Referring now to FIGS. 4 and 5, a prophetic vehicle operating sequence according to the method of FIG. 6 is shown. The vehicle operating sequence shown in FIGS. 4 and 5 may be provided via the method of FIG. 6 in cooperation with the system shown in FIG. 1. The plots shown in FIGS. 4 and 5 occur at the same time and are aligned in time. The vertical lines at t0-t4 represent times of interest during the sequence.

The first plot from the top of FIG. 4 is a plot of vehicle speed versus time. The vertical axis represents vehicle speed and the vehicle speed increases in the direction of the vertical axis arrow. The horizontal axis represents time and time increases from the left side of the figure to the right side of the figure. Trace 402 represents the vehicle speed.

The second plot from the top of FIG. 4 is a plot of left front tire state (e.g., L—lifted or G-on the ground) versus time. The vertical axis represents the state of the left front tire and the left front tire is lifted and not in contact with earth or ground when trace 404 is near the letter L along the vertical axis. The left front tire is not lifted and it is in contact with earth or ground when trace 404 is near the letter G. The horizontal axis represents time and time increases from the left side of the figure to the right side of the figure. Trace 404 represents the left front tire state.

The third plot from the top of FIG. 4 is a plot of right front tire state versus time. The vertical axis represents the state of the right front tire and the right front tire is lifted and not in contact with earth or ground when trace 406 is near the letter L along the vertical axis. The right front tire is in contact with the earth when trace 406 is near the letter G along the vertical axis. The horizontal axis represents time and time increases from the left side of the figure to the right side of the figure. Trace 406 represents the right front tire state.

The fourth plot from the top of FIG. 4 is a plot of left rear tire state versus time. The vertical axis represents the state of the left rear tire and the left rear tire is lifted and not in contact with earth or ground when trace 408 is near the letter L along the vertical axis. The left rear tire is not lifted and it is in contact with earth or ground when trace 408 is near the letter G. The horizontal axis represents time and time increases from the left side of the figure to the right side of the figure. Trace 408 represents the left rear tire state.

The fifth plot from the top of FIG. 4 is a plot of right rear tire state versus time. The vertical axis represents the state of the right rear tire and the right rear tire is lifted and not in contact with earth or ground when trace 410 is near the letter L along the vertical axis. The right rear tire is in contact with the earth when trace 410 is near the letter G along the vertical axis. The horizontal axis represents time and time increases from the left side of the figure to the right side of the figure. Trace 410 represents the right rear tire state.

The sixth plot from the top of FIG. 4 is a plot of left front wheel control mode (e.g., the operating mode of the electric machine that supplies torque to the left front wheel) versus time. The vertical axis represents and the mode of the left front wheel and the left front wheel is in torque or power control mode (e.g., the torque or power of the electric machine that provides power to the left front wheel is controlled to a requested or desired value while speed of the electric machine that provides power to the left front wheel is permitted to vary) when trace 412 is near the T/P letters along the vertical axis. The left front wheel is in a speed control mode (e.g., the speed of the electric machine that provides power to the left front wheel is controlled to a requested or desired value while torque or power of the electric machine that provides power to the left front wheel is permitted to vary) when trace 412 is near the letter N. The horizontal axis represents time and time increases from the left side of the figure to the right side of the figure. Trace 412 represents the left front tire wheel control mode.

The seventh plot from the top of FIG. 4 is a plot of right front wheel control mode versus time. The vertical axis represents and the mode of the right front wheel and the right front wheel is in torque or power control mode when trace 414 is near the T/P letters along the vertical axis. The right front wheel is in a speed control mode (e.g., the speed of the electric machine that provides power to the right front wheel is controlled to a requested or desired value while torque or power of the electric machine that provides power to the right front wheel is permitted to vary) when trace 414 is near the letter N. The horizontal axis represents time and time increases from the left side of the figure to the right side of the figure. Trace 414 represents the right front tire wheel control mode.

The eighth plot from the top of FIG. 4 is a plot of left rear wheel control mode versus time. The vertical axis represents and the mode of the left rear wheel and the left rear wheel is in torque or power control mode when trace 416 is near the T/P letters along the vertical axis. The left rear wheel is in a speed control mode when trace 416 is near the letter N. The horizontal axis represents time and time increases from the left side of the figure to the right side of the figure. Trace 416 represents the left rear tire wheel control mode.

The ninth plot from the top of FIG. 4 is a plot of right rear wheel control mode versus time. The vertical axis represents and the mode of the right rear wheel and the right rear wheel is in torque or power control mode when trace 418 is near the T/P letters along the vertical axis. The right rear wheel is in a speed control mode when trace 418 is near the letter N. The horizontal axis represents time and time increases from the right side of the figure to the right side of the figure. Trace 418 represents the right rear tire wheel control mode.

The first plot from the top of FIG. 5 is a plot of shock absorber damping rate or amount versus time. The vertical axis represents shock absorber damping rate for one of the vehicle's front wheels and the shock absorber damping rate increases in the direction of the vertical axis arrow. The horizontal axis represents time and time increases from the left side of the figure to the right side of the figure. Trace 502 represents the shock absorber damping rate.

The second plot from the top of FIG. 5 is a plot of left front tire speed versus time. The vertical axis represents the left front tire speed and the left front tire speed increases in the direction of the vertical axis arrow. The horizontal axis represents time and time increases from the left side of the figure to the right side of the figure. Trace 504 represents the left front tire speed.

The third plot from the top of FIG. 5 is a plot of right front tire speed versus time. The vertical axis represents the right front tire speed and the right front tire speed increases in the direction of the vertical axis arrow. The horizontal axis represents time and time increases from the left side of the figure to the right side of the figure. Trace 506 represents the right front tire speed.

The fourth plot from the top of FIG. 5 is a plot of left rear tire speed versus time. The vertical axis represents the left rear tire speed and the left rear tire speed increases in the direction of the vertical axis arrow. The horizontal axis represents time and time increases from the left side of the figure to the right side of the figure. Trace 508 represents the left rear tire speed.

The fifth plot from the top of FIG. 5 is a plot of right rear tire speed versus time. The vertical axis represents the right rear tire speed and the right rear tire speed increases in the direction of the vertical axis arrow. The horizontal axis represents time and time increases from the left side of the figure to the right side of the figure. Trace 510 represents the right rear tire speed.

At time t0, vehicle speed is at a middle level and all tires are on the ground. The electric machines of the front wheels and the rear wheels are operating in a torque control mode and the wheel speed of the front and rear wheels are at a medium constant level. The shock absorber damping amount is at a lower level.

At time t1, the front right and left tires leave the ground while the rear right and left tires remain on the ground. The speed of the front right and left tires begins to increase since the earth no longer resists motion of the front tires. The speed of the rear tires remains unchanged. Shortly after time t1, the electric machines driving the front right and left wheels change from torque control mode to speed control mode so that speed of the front airborne wheels may be maintained at a speed that is based on the vehicle's speed. For example, if the vehicle speed is 48 kilometers per hour the front wheel speed may be adjusted such that the tires rotate at a speed that is equivalent to the speed of the front tires when the vehicle speed is 48 kilometers per hour and the tires are on the earth and not slipping. The rear wheels remain in torque or power control mode. The vehicle speed is unchanged and the shock absorber damping amount begins to increase so that the shock absorbers may compensate for force of the front wheels engaging the earth.

At time t2, the front right and left tires remain airborne and the rear wheels leave the ground. The speed of the rear right and left tires begins to increase since the earth no longer resists motion of the rear tires. The speed of the front tires is adjusted to a speed that is based on vehicle speed. Shortly after time t2, the electric machines driving the rear right and left wheels change from torque control mode to speed control mode so that speed of the rear airborne wheels may be maintained at a speed that is based on the vehicle's speed. The electric machines driving the front wheels remain in speed control mode. The vehicle speed is reduced slowly and the shock absorber damping increases so that the shock absorbers may compensate for force of the front wheels engaging the earth.

Between time t2 and time t3, the electric machines driving the front and rear wheels remain in speed control mode and speeds of all wheels is adjusted to a speed that is based on vehicle speed. In this example, the speed of all wheels is adjusted to a speed that is based on vehicle speed when the rear wheels most recently left the ground and became airborne. For example, if just before the rear wheels left the ground, the rear wheels rotated at X radians/second, the front and rear wheels are rotated at X radians/second while the electric machines are in speed control mode. The vehicle speed decreases slowly and the shock absorber damping amount levels off at a higher level.

At time t3, the front right and left tires return to the ground while the rear right and left tires remain above the ground. The speed of the front right and left tires changes a small amount, but since it is close to a speed that matches vehicle speed, a small amount of yaw may be generated (not shown). Shortly after time t3, the electric machines driving the front right and left wheels change from speed control mode to torque or power control mode so that speed of the front wheels may generate the torque or power that is requested by the vehicle's human driver. The rear wheels remain in speed control mode in preparation for landing on the ground. The vehicle speed is slowed a small amount and the shock absorber damping amount begins to be decreased so that the shock absorbers of the front axle may compensate for unevenness in the earth's surface.

At time t4, the front right and left tires remain on the ground and the rear wheels return to the ground. The speed of the rear right and left tires changes a small amount, but since it is close to a speed that matches vehicle speed, a small amount of yaw may be generated (not shown). Shortly after time t4, the electric machines driving the rear right and left wheels change from speed control mode to torque or power control mode so that the rear wheels may generate the torque or power that is requested by the vehicle's human driver. The front wheels remain in torque or power control mode to meet the driver demand torque or power. The vehicle speed is slowed a small amount and the shock absorber damping amount is either increased or decreased so that the shock absorbers of the front axle may compensate for unevenness in the earth's surface. However, in other examples, the shock absorber damping amount may be increased depending on the driving surface. In the case of variable spring rates—the spring rate can be changed to modify ride height (wheel end position) or force to balance the vehicle upon landing. Wheel end velocities can be manipulated using a combination of damping and spring rate to optimize vehicle landing characteristics.

In this way, vehicle stability may be improved for a vehicle that has traveled through the air or jumped. In particular, by operating electric machines in a speed control mode when a vehicle's wheels are lifted off the ground, it may be possible to reduce yaw when a vehicle retouches the earth or ground.

Referring now to FIG. 6, an example method for operating a vehicle that includes electric machines coupled to one or more axles is shown. The method of FIG. 6 may be incorporated into and may cooperate with the system of FIGS. 1 and 7-9. Further, at least portions of the method of FIG. 6 may be incorporated as executable instructions stored in non-transitory memory while other portions of the method may be performed via a controller transforming operating states of devices and actuators in the physical world. The vehicle's electric machines may be operating in torque or power control modes to deliver a requested driver demand torque or power when method 600 begins or is entered.

At 602, method 600 determines vehicle operating conditions. Vehicle suspension height or positions of wheels relative to the vehicle's body or chassis, speeds of each wheel, vehicle speed, speeds of electric machines that provide torque to vehicle wheels, and driver demand torque/power request. The vehicle suspension height or the positions of wheels and tires relative to the vehicle's body or chassis may be determined via suspension sensors. The vehicle speed may be determined via a navigation system and GPS position data from satellites or via wheel speed sensors. The speeds of the electric machines may be determined via resolvers that are positioned at each electric machine. The driver demand torque/power may be determined from propulsive effort pedal position. Method 600 proceeds to 604.

At 604, method 600 determines if all vehicle wheels are at or descending to full droop (e.g., the wheels are extended away from the vehicle's body to within a threshold distance of being at a mechanical limit of the suspension travel). In other words, method 600 judges if springs in the vehicle's suspension extend the vehicle's wheels to within a threshold distance of the vehicle's wheels being at a mechanical limit of being fully extended away from the vehicle body or chassis. If so, the answer is yes and method 600 proceeds to 630. Otherwise, the answer is no and method 600 proceeds to 606.

At 606, method 600 judges if one or more vehicle wheels are at or descending to full droop. In other words, method 600 judges if one or more springs extend one or more of the vehicle's wheels to within a threshold distance of the vehicle wheel being at its mechanical limit of being fully extended away from the vehicle body or chassis. If so, the answer is yes and method 600 proceeds to 608. Otherwise, the answer is no and method 600 proceeds to 607.

At 607, method 600 does not enter a jump mode or a wheel loft mode. In addition, method 600 may continue to operate the vehicle's electric machines in torque or power control modes to deliver a requested driver demand torque or power. Method 600 proceeds to exit.

At 608, method 600 judges if speed of one or more of the vehicle's wheels is increasing or decreasing by more than a predetermined amount. In particular, method 600 judges if speed of the wheel that is at or descending to full droop is increasing at greater than a predetermined rate. Alternatively, method 600 may judge if speed of the wheel that is at or descending to full droop is decreasing at greater than a predetermined rate. If so, the answer is yes and method 600 proceeds to 610. Otherwise, the answer is no and method 600 proceeds to 609.

At 609, method 600 does not enter a jump mode or a wheel loft mode. In addition, method 600 may continue to operate the vehicle's electric machines in torque or power control modes to deliver a requested driver demand torque or power. Method 600 proceeds to exit.

At 610, method 600 judges if speed of an electric machine that is coupled to the wheel that is increasing in speed is increasing. If so, the answer is yes and method 600 proceeds to 612. Otherwise, the answer is no and method 600 proceeds to 609.

At 612, method 600 judges if vehicle speed is nearly constant (e.g., vehicle speed is not increasing or decreasing by more than 0.033 miles per second²). If so, the answer is yes and method 600 proceeds to 614 where method 600 enters a lofted or elevated wheel mode. Otherwise, the answer is no and method 600 proceeds to 609.

At 614, method 600 changes the operating mode of the electric machine that is coupled to the wheel with increasing/decreasing speed from torque or power control mode to speed control mode. Additionally, the speed of the tire that is coupled to the wheel that is increasing/decreasing in speed may be adjusted to match vehicle ground speed or a predetermined speed above or below a speed that matches vehicle ground speed. For example, if the vehicle is traveling at 30 miles/hour, then speed of the tire is adjusted to rotate at a speed at which the tire would rotate if it were rotating freely and in contact with the ground while the vehicle is traveling at 30 miles/hour with all four wheels on the ground. Electric machines that are driving other vehicle wheels may continue to drive those wheels in a torque or power control mode. In addition, speeds of front wheels may be greater than speeds of rear wheels or vice-versa during some conditions.

In one example, in one vehicle configuration where one electric machine is coupled to two front wheels and one electric machine is coupled to two rear wheels as shown in FIG. 1, if two tires of an axle are off the ground, speed of the two elevated tires is adjusted to match speed of tires that are on the ground for the vehicle's other axle. Alternatively, the speed of the two elevated tires may be adjusted to a speed that is a predetermined speed above or below a speed that matches ground speed of the vehicle. If only one tire is off the ground for this vehicle configuration, service or regenerative brakes may be applied/engaged to the elevated tire to control tire speed of the tire that is elevated from the ground.

In another example, in one vehicle configuration where each wheel is coupled to an electric machine as shown in FIG. 8, if one or more tires are off the ground, speed of the tires that are off the ground is adjusted to match speed of tires that are on the ground. For example, if a left front tire is not on the ground and the right front tire is on the ground, the speed of the left front tire is adjusted to equal the speed of the right front tire. If the right rear tire is not on the ground and the left rear tire is on the ground, the speed of the right rear tire is adjusted to a same speed as the left rear tire. If both front tires are off the ground, speed of both front tires is adjusted to speed of the rear tires that are on the ground. If both rear tires are off the ground, speed of both rear tires is adjusted to speed of the front tires that are on the ground. The speeds of the tires are adjusted via adjusting speeds of the individual electric machines that are coupled to the tires.

In still another example, in a vehicle configuration where one electric machine is coupled to two rear wheels, an electric machine is coupled to the front right wheel, and an electric machine is coupled to the front left wheel as shown in FIG. 9, if one tire is off the ground and the tire is the only tire that is coupled to an electric machine, the speed of the tire is adjusted to a speed of another tire that is in contact with the ground. If one tire is off the ground and the one tire is coupled to another tire via an axle, then speed of the tire that is off the ground may be controlled via applying a wheel brake of the elevated tire. Method 600 proceeds to 616.

At 616, method 600 judges if the suspension of the wheel that is coupled to the electric machine that is in speed control mode is being compressed. A suspension that is in its full droop position due to a tire being elevated from the ground, may be compressed when the tire encounters the ground. If the suspension of the wheel that is coupled to the electric machine that is in speed control mode is being compressed, the answer is yes and method 600 proceeds to 620. Otherwise, the answer is no and method 600 returns to 614.

At 620, method 600 switches the mode of the electric machines that are coupled to tires that were elevated from the ground from speed control mode to torque or power control mode. By switching the electric machine mode, the driver demand torque or power may be provided via the powertrain when the wheels land on the ground. Method 600 proceeds to exit.

At 630, method 600 judges if speeds of all of the vehicle's wheels (e.g., four wheels) are increasing or decreasing. In particular, method 600 judges if speeds of the wheels are increasing at greater than a predetermined rate. Alternatively, method 600 may judge if speeds of the wheels are decreasing at greater than a predetermined rate. If so, the answer is yes and method 600 proceeds to 632. Otherwise, the answer is no and method 600 proceeds to 609.

At 632, method 600 judges if speeds electric machine that are coupled to the wheels is increasing. If so, the answer is yes and method 600 proceeds to 634. Otherwise, the answer is no and method 600 proceeds to 609.

At 634, method 600 judges if vehicle speed is nearly constant. If so, the answer is yes and method 600 proceeds to 636 where method 600 enters a jump mode. Otherwise, the answer is no and method 600 proceeds to 609.

At 636, method 600 changes the operating modes of the electric machines that are coupled to the wheels from torque or power control mode to speed control mode. Additionally, the speed of the tires that are coupled to the wheels is adjusted to match vehicle ground speed or a predetermined speed above the vehicle's present ground speed. For example, if the vehicle is traveling at 30 miles/hour, then speeds of the tires are adjusted to rotate at speeds at which the tires would rotate if they were rotating freely and in contact with the ground while the vehicle is traveling at 30 miles/hour with all four wheels on the ground. In another example, speed of the vehicle's front wheels may be adjusted to a speed that is a predetermined speed above a speed that the wheels would rotate if the vehicle were traveling at its present speed with all for tires on the ground and where the tires are not spinning. The vehicle's rear wheels may be adjusted to a speed that is a predetermined speed below a speed that the wheels would rotate if the vehicle were traveling at its present speed with all for tires on the ground and where the tires are not spinning. In addition, the vehicle's front left wheel may be rotated at a speed that is greater or less than speed of the front right wheel. Likewise, the vehicle's rear left wheel may be rotated at a speed that is greater than speed of the rear right wheel. Thus, a speed of each wheel may be adjusted to a speed that is unique from speed of other wheels in an effort to improve vehicle stability. Further, speed of each wheel may be independently adjusted from other wheel speeds as a function of, or in response to, yaw of the vehicle when the vehicle is airborne to improve vehicle stability. The Method 600 proceeds to 638.

At 638, method 600 judges if the suspension of the wheel that is coupled to the electric machine that is in speed control mode is being compressed. A suspension that is in its full droop position due to a tire being elevated from the ground, may be compressed when the tire encounters the ground. If the suspension of the wheel that is coupled to the electric machine that is in speed control mode is being compressed, the answer is yes and method 600 proceeds to 620. Otherwise, the answer is no and method 600 returns to 636.

In this way, it may be possible to improve vehicle stability when a vehicle a vehicle jumps and temporarily is above the earth. Specifically, electric machines that were in torque control mode may be switched to a speed control mode so that little yaw may be generated when the vehicle lands back to earth. In addition, wheel and tire speed may be controlled when a single tire is elevated from the earth so that vehicle stability and drivability may be improved. In addition, it may be advantageous to apply overspeed or underspeed to a one or more wheel or axle rotation rate to promote stability or managing landing attitude.

The method of FIG. 6 provides for a method for operating a vehicle, comprising: operating an electric machine in a torque control mode or a power control mode; and switching the electric machine from the torque control mode or the power control mode into a speed control mode in response to an indication that one or more vehicle tires has lost contact with earth. The method includes where the indication is speed of a wheel increasing. The method includes where the indication is wheel travel relative to a body of a vehicle. The method includes where the electric machine supplies torque to a first axle and a second axle. The method includes where the electric machine supplies torque to solely one wheel. The method includes where the electric machine supplies torque solely to one axle. The method further comprises switching the electric machine from the speed control mode back to the torque control or power control mode in response to the tire contacting earth.

The method of FIG. 6 also provides for a method for operating a vehicle, comprising: operating an electric machine in a torque control mode or a power control mode; and switching the electric machine from the torque control mode or the power control mode into a speed control mode in response to an indication that one or more vehicle tires has lost contact with earth; and rotating the one or more tires that has lost contact with earth at a speed that is based on vehicle ground speed. The method includes where the one or more tires are rotated at the speed according to a speed of a second tire. The method includes where the one or more tires are rotated at the speed according to a speed of a second tire when the second tire was last in contact with earth. The method further comprises switching the electric machine to the torque control mode or power control mode in response to the one or more vehicle tires being in contact with earth. The method further comprises increasing a damping amount of a shock absorber in response to the indication that one or more vehicle tires have lost contact with earth.

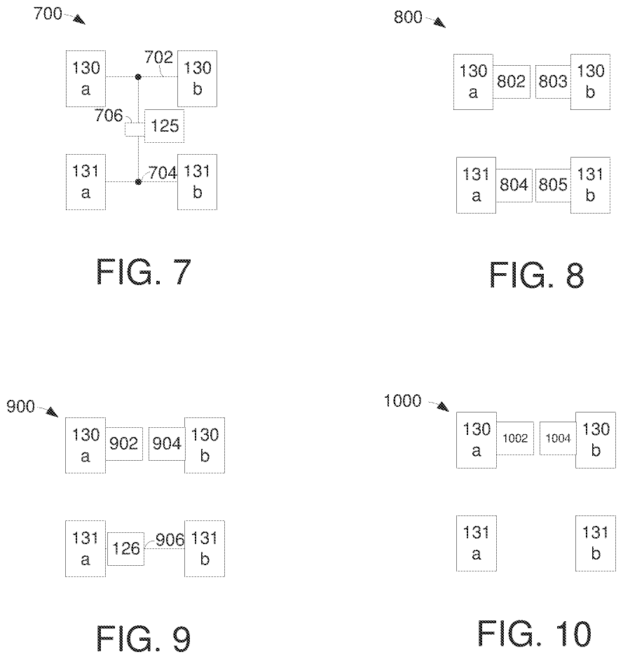

The vehicle configurations shown in FIGS. 7-13 may include a controller, control system, electric energy storage device, and other devices shown in FIG. 1. These items are not shown in FIGS. 7-13 for the sake of brevity, but it should be appreciated that such devices may be included in these configurations as well to control and manage vehicle operation.

Referring now to FIG. 7, another example vehicle configuration that the present method may be applied to is shown. Vehicle configuration 700 includes a front left tire 130a and a front right tire 130b. Vehicle configuration 700 also includes a rear left tire 131a and a rear right tire 131b. The tires are driven via a single or sole electric machine 125. Electric machine 125 supplies torque to transfer case 706 and transfer case distributes torque to front axle 702 and rear axle 704. Front axle 702 may supply torque to front tires 130a and 130b. Rear axle 704 may supply torque to rear tires 131a and 131b.

Referring now to FIG. 8, another example vehicle configuration that the present method may be applied to is shown. Vehicle configuration 800 includes a front left tire 130a and a front right tire 130b. Vehicle configuration 800 also includes a rear left tire 131a and a rear right tire 131b. Each of the tires is driven via a single or sole electric machine. For example, electric machine 802 drives only tire 130a. Electric machine 803 drives only tire 130b. Similarly, electric machine 804 drives only tire 131a and electric machine 805 drives only tire 131b.

Referring now to FIG. 9, another example vehicle configuration that the present method may be applied to is shown. Vehicle configuration 900 includes a front left tire 130a and a front right tire 130b. Vehicle configuration 900 also includes a rear left tire 131a and a rear right tire 131b. Each of the front tires is driven via a single or sole electric machine. For example, electric machine 902 drives only tire 130a. Electric machine 903 drives only tire 130b. Rear wheels 131a and 131b are both driven only by electric machine 126. Electric machine 126 may supply torque to axle 906 and axle 906 may transfer torque to rear wheels 131a and 131b.

Referring now to FIG. 10, an example front wheel drive vehicle configuration that the present method may be applied to is shown. Vehicle configuration 1000 includes a front left tire 130a and a front right tire 130b. Vehicle configuration 1000 also includes a rear left tire 131a and a rear right tire 131b. Each of the front tires is driven via individual electric machines. For example, electric machine 1002 drives only left front tire 130a. Electric machine 1003 drives only right front tire 130b. Rear wheels 131a and 131b are not driven.

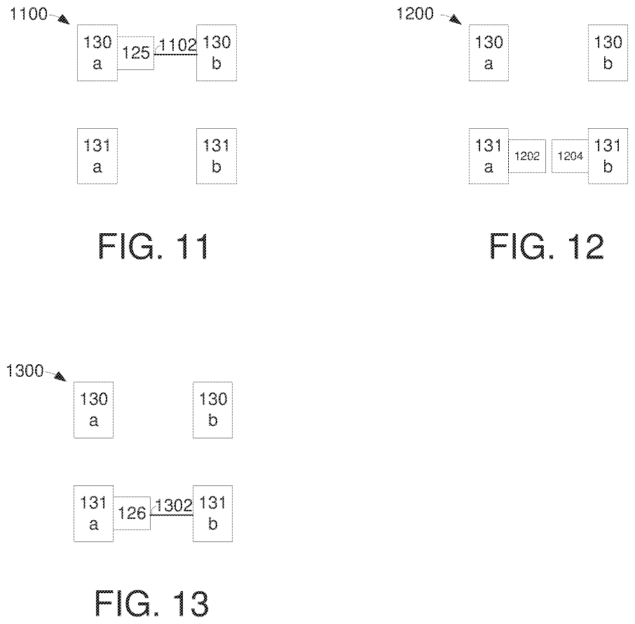

Referring now to FIG. 11, a second example front wheel drive vehicle configuration that the present method may be applied to is shown. Vehicle configuration 1100 includes a front left tire 130a and a front right tire 130b. Vehicle configuration 1100 also includes a rear left tire 131a and a rear right tire 131b. Both of the front tires are driven via a single or sole electric machine. For example, electric machine 125 drives tire 130a and tire 130b. Rear wheels 131a and 131b are not driven.

Referring now to FIG. 12, an example rear wheel drive vehicle configuration that the present method may be applied to is shown. Vehicle configuration 1200 includes a front left tire 130a and a front right tire 130b. Vehicle configuration 1200 also includes a rear left tire 131a and a rear right tire 131b. Each of the rear tires is driven via a single or sole electric machine. For example, electric machine 1202 drives only left rear tire 131a. Electric machine 1203 drives only right rear tire 131b. Front tires 130a and 130b are not driven.

Referring now to FIG. 13, a second example rear wheel drive vehicle configuration that the present method may be applied to is shown. Vehicle configuration 1200 includes a front left tire 130a and a front right tire 130b. Vehicle configuration 1200 also includes a rear left tire 131a and a rear right tire 131b. Neither of the front tires is driven. Both of the rear tires are driven via a single or sole electric machine. For example, electric machine 126 drives left rear tire 131a and right rear tire 131b. In particular, electric machine 126 may supply torque to axle 1306 and axle 1306 may transfer torque to rear wheels 131a and 131b.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a vehicle, comprising:
operating an electric machine in a torque control mode or a power control mode; and
switching the electric machine from the torque control mode or the power control mode into a speed control mode in response to an indication that one or more vehicle tires has lost contact with earth.

2. The method of claim 1, where the indication is speed of a wheel increasing.

3. The method of claim 1, where the indication is wheel travel relative to a body of the vehicle.

4. The method of claim 1, where the electric machine supplies torque to a first axle and a second axle.

5. The method of claim 1, where the electric machine supplies torque to solely one wheel, and further comprising adjusting speeds of two different wheels to two different speeds to promote vehicle stability in response to an indication that one or more vehicle tires has lost contact with earth.

6. The method of claim 1, where the electric machine supplies torque solely to one axle.

7. The method of claim 6, further comprising switching the electric machine from the speed control mode back to the torque control or power control mode in response to the one or more tires contacting earth.

8. A vehicle system, comprising:
a first electric machine coupled to a wheel and a tire;
a controller including executable instructions stored in non-transitory memory that cause the controller to operate the first electric machine in a torque or power control mode when the tire is in direct contact with earth, and operate the first electric machine in a speed control mode when the tire is not in direct contact with earth.

9. The system of claim 8, further comprising additional instructions to rotate the tire while the tire is not in contact with earth at a speed that is based on a speed of a second tire.

10. The system of claim 8, further comprising additional instructions to rotate the tire while the tire is not in contact with earth at a speed that is based on a speed of a second tire, the second tire a last tire of a vehicle in contact with earth.

11. The system of claim 10, where the tire is rotated at the speed when all tires are not in contact with earth.

12. The system of claim 8, further comprising a second electric machine and additional instructions to operate the second electric machine in the torque or power control mode while the first electric machine is operated in the speed control mode.

13. The system of claim 8, further comprising a second electric machine and additional instructions to operate the second electric machine in a second speed control mode while the first electric machine is operated in the speed control mode.

14. The system of claim 8, further comprising additional instructions to determine that the tire is not in direct communication with earth based on a speed change of the first electric machine.

15. The system of claim 8, further comprising additional instructions to determine that the tire is not in direct communication with earth based on output of a suspension sensor.

16. A method for operating a vehicle, comprising:
operating an electric machine in a torque control mode or a power control mode; and
switching the electric machine from the torque control mode or the power control mode into a speed control mode in response to an indication that one or more tires has lost contact with earth; and
rotating the one or more tires that has lost contact with earth at a speed that is based on vehicle ground speed.

17. The method of claim 16, where the one or more tires are rotated at the speed according to a speed of a second tire.

18. The method of claim 16, where the one or more tires are rotated at the speed according to a speed of a second tire when the second tire was last in contact with earth.

19. The method of claim 16, further comprising switching the electric machine to the torque control mode or power control mode in response to the one or more vehicle tires being in contact with earth.

20. The method of claim 16, further comprising increasing or decreasing a damping amount of a shock absorber and increasing or decreasing a spring rate of an adjustable spring in response to the indication that one or more vehicle tires has lost contact with earth.
